(19) United States
(12) Patent Application Publication
(10) Pub. No.: US 2022/0169767 A1
(43) Pub. Date: Jun. 2, 2022

(54) POWDERY PAPER STRENGTHENING AGENT, METHOD FOR PRODUCING POWDERY PAPER STRENGTHENING AGENT, PAPER STRENGTHENING AGENT SOLUTION AND PAPER

(71) Applicant: Arakawa Chemical Industries, Ltd., Osaka (JP)

(72) Inventors: Shogo NISHIURA, Osaka (JP); Daisuke FUJIOKA, Osaka (JP); Keisuke OKADA, Osaka (JP)

(73) Assignee: Arakawa Chemical Industries, Ltd., Osaka (JP)

(21) Appl. No.: 17/425,837

(22) PCT Filed: Feb. 20, 2020
(86) PCT No.: PCT/JP2020/006869

§ 371 Date: Jan. 7, 2022

(30) Foreign Application Priority Data
Mar. 15, 2019 (JP) 2019-048322

(51) Int. Cl. C08F 220/56; D21H 17/37; D21H 21/18

(52) U.S. Cl. CPC C08F 220/56; D21H 21/18; D21H 17/37

(57) ABSTRACT

A powdery paper-strengthening agent, comprising a branched (meth)acrylamide-based polymer (A) having a weight-average molecular weight of 1,000,000 to 8,000,000 and a molecular weight distribution of 1.4 to 3.0, wherein the branched (meth)acrylamide-based polymer (A) comprises, as constituent monomers, a (meth)acrylamide (a1), a crosslinkable unsaturated monomer (a2), and at least one of a cationic unsaturated monomer (a3) and an anionic unsaturated monomer (a4), and wherein a content of unreacted (a1) component is 1,000 ppm or less.

### TECHNICAL FIELD

The present invention relates to a powdery paper-strengthening agent, a method of producing the powdery paper-strengthening agent, a paper-strengthening agent solution, and paper.

### BACKGROUND ART

The powdery paper-strengthening agent is obtained by reducing a paper-strengthening agent to powder, and does not cause hydrolysis of a cation component that occurs in an aqueous solution type during long-term storage, and therefore it has an advantage of having a small decline in paper-strengthening effect over time. Moreover, in general, in order to exhibit excellent paper-strengthening effect when made into paper, the paper-strengthening agent is required to have branched structures, a high molecular weight, and a controlled molecular weight distribution.

As a paper-strengthening agent, a (meth)acrylamide-based polymer obtained by polymerizing a monomer component comprising (meth)acrylamide is mainly used, and a powdery (meth)acrylamide-based polymer is known to be obtained by polymerizing a monomer component by heat or ultraviolet irradiation (the former is referred to as a “boiling polymerization method” and the latter is referred to as a “ultraviolet polymerization method”) (Patent Documents 1 and 2).

### PRIOR ART DOCUMENT

### Patent Document

Patent Document 1: WO 2011/122405
Patent Document 2: WO 2013/031245

### SUMMARY OF THE INVENTION

However, in the case of the boiling polymerization method, a linear (meth)acrylamide-based polymer can achieve a high molecular weight, while a branched (meth)acrylamide-based polymer is difficult to control the reaction when trying to introduce branched structures, and therefore the weight-average molecular weight becomes low, and the molecular weight distribution becomes wide, which makes it difficult to exhibit sufficient paper-strengthening effect. Moreover, in the case of the ultraviolet polymerization method, as compared with the boiling polymerization method, the reaction can be controlled according to an irradiation time and an irradiation amount, though the weight-average molecular weight becomes low, which makes it difficult to exhibit sufficient paper-strengthening effect, and a number of (meth)acrylamides are likely to remain unreacted.

It is an object of the present invention to provide a powdery paper-strengthening agent having a high molecular weight and a controlled molecular weight distribution and exhibiting excellent paper-strengthening effect, a method of producing the powdery paper-strengthening agent, a paper-strengthening agent solution comprising the powdery paper-strengthening agent, and paper using the paper-strengthening agent solution.

As a result of intensive studies, the present inventors have found that the above-described problem can be solved with a powdery paper-strengthening agent comprising a branched (meth)acrylamide-based polymer having appropriately adjusted type and content of respective monomer component and exhibiting specific weight-average molecular weight and molecular weight distribution, and completed the present invention.

The powdery paper-strengthening agent of the present invention that solves the above-described problem comprises a branched (meth)acrylamide-based polymer (A) having a weight-average molecular weight of 1,000,000 to 8,000,000 and a molecular weight distribution of 1.4 to 3.0, wherein the branched (meth)acrylamide-based polymer (A) comprises (meth)acrylamide (a1), a crosslinkable unsaturated monomer (a2), and at least one of a cationic unsaturated monomer (a3) and an anionic unsaturated monomer (a4), as constituent monomers, and wherein a content of unreacted (a1) component is 1,000 ppm or less.

The method of producing a powdery paper-strengthening agent of the present invention that solves the above-described problem is a method of producing a powdery paper-strengthening agent for producing the above-described powdery paper-strengthening agent, comprising step (I) of polymerizing a monomer component comprising the (a1) component, the (a2) component, and at least one of the (a3) component and the (a4) component to obtain a branched (meth)acrylamide-based polymer (A) (hereinafter, referred to as the “step (I)”) and step (II) of precipitating the (A) component in an organic solvent (B) (hereinafter, referred to as the “step (II)”).

The paper-strengthening agent solution of the present invention that solves the above-described problem is a paper-strengthening agent solution comprising the above-described powdery paper-strengthening agent and water.

The paper of the present invention that solves the above-described problem is paper obtained by using the above-described paper-strengthening agent solution.

### EMBODIMENT FOR CARRYING OUT THE INVENTION

### <Powdery Paper-Strengthening Agent>

The powdery paper-strengthening agent according to one embodiment of the present invention comprises a branched (meth)acrylamide-based polymer (A) (hereinafter, also referred to as an (A) component) having a weight-average molecular weight of 1,000,000 to 8,000,000 and a molecular weight distribution of 1.4 to 3.0. The branched (meth)acrylamide-based polymer (A) comprises a (meth)acrylamide (a1) (hereinafter, referred to as an (a1) component), a crosslinkable unsaturated monomer (a2) (hereinafter, referred to as an (a2) component), and at least one of a cationic unsaturated monomer (a3) (hereinafter, referred to as an (a3) component) and an anionic unsaturated monomer (a4) (hereinafter, referred to as an (a4) component), as constituent monomers. The powdery paper-strengthening agent comprises 1,000 ppm or less of unreacted (a1) component. Besides, a “(meth)acryl” means methacryl or acryl, and an “unsaturated monomer” means one having one or more double bonds or triple bonds in one molecule of a monomer (hereinafter, the same shall apply).

The (a1) component comprises methacrylamide and acrylamide. The (a1) component may be used in combination.

A content of the (a1) component is not particularly limited. By way of an example, the content of the (a1) component is preferably 59.5 to 98 mol %, more preferably 60 to 98 mol %, further preferably 60 to 90 mol %, in the constituent monomers. When the content of the (a1) component is within the above-described ranges, the powdery paper-strengthening agent can impart sufficient paper-strengthening effect to the paper.

The (a2) component is a component for introducing branched structures into the (A) component. The (a2) component is not particularly limited. By way of an example, the (a2) component is N-alkyl (meth)acrylamide such as N-methyl (meth)acrylamide, N-ethyl (meth)acrylamide, N-isopropyl (meth)acrylamide, and N-t-butyl (meth)acrylamide; N,N-dialkyl (meth)acrylamide such as N,N-dimethylacrylamide, N,N-diethyl (meth)acrylamide, and N,N-diisopropyl (meth)acrylamide; N,N′-alkylene bis (meth)acrylamide such as N,N′-methylene bis (meth)acrylamide and N,N′-ethylene bis (meth)acrylamide; a triallyl group-containing crosslinkable unsaturated monomer such as triallyl isocyanurate, triallyl trimellitate, triallylamine, and triallyl (meth)acrylamide; (meth)acryloyl group-containing triazine such as 1,3,5-triacrylloyl-1,3,5-triazine and 1,3,5-triacrylloylhexahydro-1,3,5-triazine, or the like. The (a2) component may be used in combination. Among them, the (a2) component can increase the weight-average molecular weight of the (A) component and exhibits high paper-strengthening effect when paper is produced with the obtained powdery paper-strengthening agent, and therefore it is preferably at least one selected from the group consisting of N,N′-dialkyl (meth)acrylamide, N,N′-alkylene bis (meth)acrylamide, and (meth)acryloyl group-containing triazine, more preferably N,N-dimethylacrylamide or N,N′-methylene bisacrylamide.

A content of the (a2) component is not particularly limited. By way of an example, the content of the (a2) component is preferably 0.001 to 1 mol % from the viewpoints of allowing for increase in weight-average molecular weight of the (A) component and exhibiting high paper-strengthening effect when paper is produced with the obtained powdery paper-strengthening agent, more preferably 0.001 to 0.8 mol %, further preferably 0.001 to 0.5 mol %, from the viewpoint of suppressing gelation of a polymer produced by progress of an excessive cross-linking reaction while increasing the weight-average molecular weight, in the constituent monomers.

The (a3) component is not particularly limited. By way of an example, various known components can be used as (a3) components, preferably a secondary amino group-containing unsaturated monomer, a tertiary amino group-containing unsaturated monomer, and quaternized salts of these unsaturated monomers.

The secondary amino group-containing unsaturated monomer is not particularly limited. By way of an example, the secondary amino group-containing unsaturated monomer is diallylamine or the like. The tertiary amino group-containing unsaturated monomer is not particularly limited. By way of an example, the tertiary amino group-containing unsaturated monomer is a tertiary amino group-containing (meth)acrylate such as N,N-dimethylaminoethyl (meth)acrylate and N,N-diethylaminoethyl (meth)acrylate; a tertiary amino group-containing (meth)acrylamide such as N,N-dimethylaminopropyl (meth)acrylamide and N,N-diethylaminopropyl (meth)acrylamide, or the like. The quaternized salts of these unsaturated monomers mean those obtained by reacting the above-described secondary amino group-containing unsaturated monomer or the above-described tertiary amino group-containing unsaturated monomer with a quaternizing agent. The quaternized salt may be an inorganic acid salt such as hydrochloride and sulfate, or an organic acid salt such as acetate. Moreover, the quaternizing agent is methyl chloride, benzyl chloride, dimethyl sulfate, epichlorohydrin, or the like. They may be used in combination. Among them, the (a3) component preferably comprises at least one of a tertiary amino group-containing (meth)acrylate and a quaternized salt of a tertiary amino group-containing (meth)acrylate from the viewpoint of high copolymerizability with the (a1) component, more preferably a quaternized salt of N,N-dimethylaminoethyl (meth)acrylate, further preferably N,N-dimethylaminoethyl acrylate benzyl chloride, from the viewpoint that an (A) component having a higher weight-average molecular weight can be obtained. Besides, (meth)acrylate means methacrylate or acrylate.

A content of the (a3) component is not particularly limited. By way of an example, the content of the (a3) component is preferably 0.5 to 20 mol %, more preferably 0.6 to 20 mol %, further preferably 0.6 to 10 mol %, in the constituent monomers, from the viewpoints that the (A) component becomes easily adsorbed on a pulp and high paper-strengthening effect is easily exhibited when drying into paper.

The (a4) component is not particularly limited as long as it has an anionic property. By way of an example, various known components can be used as (a4) components, preferably unsaturated carboxylic acids such as (meth)acrylic acid, itaconic acid, itaconic anhydride, fumaric acid, and maleic acid; unsaturated sulfonic acids such as vinyl sulfonic acid and methallylsulfonic acid. These acids may be alkali metal salts such as sodium and potassium, and salts such as an ammonium salt. The (a4) component may be used in combination.

A content of the (a4) component is not particularly limited. By way of an example, the content of the (a4) component is preferably 0.5 to 20 mol % from the viewpoints that interaction with a cationic paper chemical (for example, aluminum sulfate, etc.) added during papermaking is easily enhanced and paper-strengthening effect of paper is easily improved, more preferably 0.5 to 10 mol %, further preferably 0.5 to 5 mol %, from the viewpoint that the paper-strengthening effect of paper is more easily improved, in the constituent monomers.

In the present embodiment, by increasing the weight-average molecular weight of the (A) component to adjust it to 1,000,000 to 8,000,000, high paper-strengthening effect is exhibited when paper is produced using the obtained powdery paper-strengthening agent, and therefore it is preferable that the constituent monomer comprises at least ones of unsaturated sulfonic acids and salts thereof, and it is more preferable that it comprises methallylsulfonic acid and sodium methallylsulfonate.

A content of unsaturated sulfonic acids is not particularly limited. By way of an example, the content of unsaturated sulfonic acids is preferably 0.1 to 2 mol %, more preferably 0.1 to 1 mol %, in the constituent monomers, from the viewpoints that the weight-average molecular weight of the (A) component is easily increased and high paper-strengthening effect when paper is produced using the obtained powdery paper-strengthening agent is easily exhibited.

The constituent monomer of the present embodiment may comprise unsaturated monomers (a5) (hereinafter, referred to as (a5) component) other than the (a1) to (a4) components. The (a5) component is not particularly limited. By way of an example, the (a5) component is aromatic unsaturated monomer such as styrene, α-methylstyrene, and vinyltoluene; (meth)acrylic acid alkyl ester such as methyl (meth)acrylate, ethyl (meth)acrylate, n-propyl (meth)acrylate, n-butyl (meta)acrylate, 2-ethylhexyl (meth)acrylate, and cyclohexyl (meth)acrylate; a carboxylic acid vinyl ester such as vinyl acetate and vinyl propionate; acrylonitrile, or the like. The (a5) component may be used in combination.

When the constituent monomer comprises an (a5) component, a content of the (a5) component is not particularly limited. By way of an example, the content of the (a5) component is less than 5 mol % in the constituent monomers.

In the production of the (A) component, components (a6) (hereinafter referred to as (a6) component) other than the (a1) to (a5) components may be used. The components (a6) are not particularly limited. By way of an example, the components (a6) are mercaptans such as 2-mercaptoethanol and n-dodecyl mercaptan; alcohols such as ethanol, isopropyl alcohol, and n-pentyl alcohol; aromatic compounds such as α-methylstyrene dimer, ethylbenzene, isopropylbenzene, and cumene; organic acids such as carbon tetrachloride, citric acid, succinic acid, and oxalic acid; inorganic acids such as hydrochloric acid, sulfuric acid, and phosphoric acid; inorganic bases such as sodium hydroxide, potassium hydroxide, and calcium hydroxide; additives such as an anti-foaming agent and an antioxidant, or the like. The components (a6) may be used in combination.

When the constituent monomer comprises an (a6) component, a content of the (a6) component is not particularly limited. By way of an example, the content of the (a6) component is 5 parts by mass or less based on 100 parts by mass of the constituent monomers.

An average particle size of the powdery paper-strengthening agent of the present embodiment is not particularly limited. By way of an example, the average particle size is preferably about 0.01 to 2 mm from the viewpoint of easy solubility to a solvent such as water. Besides, the average particle size can be measured using, for example, an optical microscope.

A weight-average molecular weight of the (A) component (a value obtained by gel permeation chromatography (GPC) method) is 1,000,000 to 8,000,000, preferably 1,500,000 to 8,000,000, more preferably 2,000,000 to 8,000,000, further preferably 2,000,000 to 7,000,000. When the weight-average molecular weight is less than 1,000,000, the powdery paper-strengthening agent has low paper-strengthening effect. Moreover, when the weight-average molecular weight exceeds 8,000,000, the molecular weight distribution of the (A) component tends to prevail, and the formation of the paper tends to deteriorate.

The molecular weight distribution (Mw/Mn) of the (A) components (a value obtained by gel permeation chromatography (GPC) method) is 1.4 to 3.0, preferably 1.4 to 2.8, more preferably 1.4 to 2.6. When the molecular weight distribution (Mw/Mn) exceeds 3.0, the formation of the paper tends to be disturbed, and the paper-strengthening effect tends to decrease. On the other hand, when the molecular weight distribution (Mw/Mn) is less than 1.4, the obtained paper becomes easily affected by fluctuations in papermaking temperature, papermaking pH, and the like, and the paper-strengthening effect and the like tend to deteriorate. Here, Mw is an abbreviation for weight-average molecular weight and Mn is an abbreviation for number average molecular weight.

A content of unreacted (a1) component contained in the powdery paper-strengthening agent of the present embodiment is 1,000 ppm or less. When the content of unreacted (a1) component exceeds 1,000 ppm, the powdery paper-strengthening agent deteriorates in storage stability during long-term storage, and the paper-strengthening effect of the paper tends to be easily reduced when used during papermaking. The content of unreacted (a1) component is preferably 800 ppm or less, more preferably 500 ppm or less. Besides, the content of unreacted (a1) component can be calculated by a method of measurement using liquid chromatography, or the like.

As described above, the powdery paper-strengthening agent of the present embodiment has a high molecular weight and a controlled molecular weight distribution, and exhibits excellent paper-strengthening effect.

### <Method of Producing Powdery Paper-Strengthening Agent>

A method of producing a powdery paper-strengthening agent according to one embodiment of the present invention is the above-described method of producing a powdery paper-strengthening agent. The method of producing a powdery paper-strengthening agent comprises step (I) of polymerizing a monomer component comprising an (a1) component, an (a2) component, and at least one of an (a3) component and an (a4) component to obtain a branched (meta)acrylamide-based polymer (A) and step (II) of precipitating the (A) component with an organic solvent (B). According to the method of producing a powdery paper-strengthening agent of the present embodiment, branched structures can be introduced while suppressing the production of insoluble matters such as gel. As a result, the obtained (A) component exhibits a high weight-average molecular weight and a specific molecular weight distribution. Moreover, the obtained powdery paper-strengthening agent exhibits excellent paper-strengthening effect. Each step will be described as follows.

### <Step (I)>

The step (I) is a step of polymerizing a monomer component comprising an (a1) component, an (a2) component, and at least one of an (a3) component and an (a4) component to obtain a branched (meth)acrylamide-based polymer (A). If necessary, the step (I) may comprise a step of dissolving an (a5) component in a solvent and polymerizing it (hereinafter, referred to as “solution polymerization”).

The solution polymerization is a method of polymerizing (a1) to (a4) components and, if necessary, (a5) to (a6) components in the presence of a polymerization initiator in a solvent to obtain a solution of a (meth)acrylamide-based polymer by, for example, a conventionally known drop polymerization method, a simultaneous polymerization method, a combined method thereof, or the like.

Examples of the solvent include water, an organic solvent, and the like. The solvent may be used in combination. The organic solvent is not particularly limited. By way of an example, the organic solvent is alcohol such as methanol, ethanol, n-propyl alcohol, isopropyl alcohol, n-butyl alcohol, sec-butyl alcohol, t-butyl alcohol, isobutyl alcohol, n-hexyl alcohol, n-octyl alcohol, ethylene glycol, propylene glycol, diethylene glycol, triethylene glycol, and diacetone alcohol; ether such as ethylene glycol monobutyl ether, propylene glycol monomethyl ether, and propylene glycol monoethyl ether, or the like. Among them, the solvent is preferably water from the viewpoint that the (a1) to (a6) components can be easily dissolved.

A polymerization condition is not particularly limited. By way of an example, examples of the polymerization condition include a method of adding a mixed solution of (a1) to (a4) components and, if necessary, (a5) and (a6) components and a solution of a polymerization initiator into a solvent (preferably water) charged in a reactor in advance, followed by polymerizing the mixture at about 50 to 100° C. for 1 to 8 hours, and the like.

The polymerization initiator is not particularly limited. By way of an example, the polymerization initiator is persulfate such as ammonium persulfate, potassium persulfate, and sodium persulfate; an azo-based compound such as 2,2′-azobis(2-amidinopropane) dihydrochloride and 2,2′-azobis[2(2-imidazoline-2-yl)propane]dihydrochloride; hydrogen peroxide, or the like. The polymerization initiator may be used in combination. Among them, the polymerization initiator is preferably ammonium persulfate, potassium persulfate, or 2,2′-azobis(2-amidinopropane) dihydrochloride, from the viewpoint of sufficiently advancing solution polymerization. Moreover, the method of adding the polymerization initiator is not particularly limited. By way of an example, the method of adding the polymerization initiator is batch addition, partial addition, continuous dropping, or the like.

Moreover, a content of the polymerization initiator is not particularly limited. By way of an example, the content of the polymerization initiator is about 0.001 to 5 parts by mass, preferably about 0.01 to 1 part by mass, based on 100 parts by mass of the (a1) to (a4) components. When the content of the polymerization initiator is within the above-described ranges, the polymerization reaction can be easily controlled, and an (A) component showing a weight-average molecular weight which will be described later can be easily obtained.

Additives such as an anti-foaming agent, an antioxidant, a preservative, a chelating agent, a water-soluble aluminum compound, Glauber's salt, urea, and polysaccharide may be further added to the solution of the (A) component.

### <Step (II)>

The step (II) is a step of precipitating an (A) component with an organic solvent (B) (hereinafter, referred to as a (B) component). The step (II) of the present embodiment is preferably a step of dropping, charging, and discharging a solution of an (A) component into a (B) component to form a precipitate from the viewpoint that a content of monomer such as an unreacted (a1) component can be further reduced.

The (B) component is not particularly limited. By way of an example, the (B) component is preferably one that can remove an unreacted (a1) component and a low molecular weight component without dissolving the (A) component. According to such a (B) component, the (A) component is easily adjusted to a high weight-average molecular weight (1,000,000 to 8,000,000), and the molecular weight distribution is also easily adjusted to the above-described numerical range (1.5 to 3.0). As a result, when paper is produced using the obtained powdery paper-strengthening agent, the formation of the obtained paper is less likely to be disturbed and exhibits excellent paper-strengthening effect. Moreover, by precipitating the (A) component with the (B) component, a content of unreacted (meth)acrylamide contained in the (A) component is easily reduced.

The (B) component is preferably one that is easily miscible with the solvent used in the step (I). For example, when “water” is used as the solvent in the step (I), the (B) component is preferably an organic solvent miscible with water. The organic solvent miscible with water is not particularly limited. By way of an example, the organic solvent miscible with water is monoalcohol such as methanol, ethanol, n-propyl alcohol, and isopropyl alcohol; ketone such as acetone, ethyl methyl ketone, and diethyl ketone; diethyl ether, ethyl propyl ether, di-n-propyl ether, n-butyl ethyl ether, di-n-butyl ether, t-butyl ethyl ether, or the like. The organic solvent may be used in combination.

Moreover, the organic solvent miscible with water is preferably one having a boiling point of 80° C. or lower, more preferably 30 to 70° C., from the viewpoint of easily volatilizing when the powdery paper-strengthening agent is dried. By way of an example, such an organic solvent is monoalcohol such as methanol and ethanol; ketone such as acetone; ether such as diethyl ether, ethyl propyl ether, and t-butyl ethyl ether, or the like. The organic solvent may be used in combination. Among them, the organic solvent is preferably one or more selected from the group consisting of monoalcohol, acetone, and diethyl ether, more preferably one or more selected from the group consisting of methanol, acetone, and diethyl ether, from the viewpoints that a content of monomer such as an unreacted (a1) component can be further reduced, and an amount of heat during drying of the powdery paper-strengthening agent can be reduced.

An amount of the organic solvent miscible with water to be used is not particularly limited. By way of an example, the amount of the organic solvent miscible with water is preferably about 300 to 10,000 parts by mass based on 100 parts by mass of the solution of the (A) component from the viewpoint of more efficiently precipitating the (A) component.

Moreover, in addition to the organic solvent miscible with water, an organic solvent immiscible with water may be mixed. The organic solvent immiscible with water is not particularly limited. By way of an example, the organic solvent immiscible with water is ester such as methyl acetate and ethyl acetate; a saturated hydrocarbon such as n-pentane, n-hexane, and n-heptane, or the like. The organic solvent immiscible with water may be used in combination.

An amount of the organic solvent immiscible with water is not particularly limited. By way of an example, the amount of the organic solvent immiscible with water to be used is preferably less than 50 parts by mass based on 100 parts by mass of the solution of the (A) component from the viewpoint of preventing an organic solvent phase from being separated from an aqueous phase.

After forming a precipitate, the obtained precipitate of the (A) component can be recovered by filtering with a wire mesh or the like. The recovered precipitate of the (A) component is preferably dried since it volatilizes the organic solvent. A drying method is not particularly limited. By way of an example, the drying method is a hot air drying, a conduction heat transfer drying, a radiant heat drying, or the like. Moreover, a drying condition is of a temperature at about 50 to 150° C. (preferably 50 to 105° C.) and about 30 to 240 minutes (preferably 30 to 180 minutes).

The powdery paper-strengthening agent of the present embodiment can be obtained by pulverizing a dried (A) component by various known methods.

A pulverizing method is not particularly limited. By way of an example, the pulverizing method is by way of a grinder (a stone mill type grinder), a high pressure homogenizer or an ultrahigh pressure homogenizer, a high pressure collision type crusher, a ball mill, a bead mill, a vibration mill, or the like.

An average particle size of the powdery paper-strengthening agent obtained by the above-described method is not particularly limited. By way of an example, the average particle size of the powdery paper-strengthening agent is preferably about 0.01 to 2 mm from the viewpoint of being easily dissolved in a solvent such as water.

Moreover, the weight-average molecular weight of the obtained (A) component is 1,000,000 to 8,000,000, preferably 1,500,000 to 8,000,000, more preferably 2,000,000 to 8,000,000, and further preferably 2,000,000 to 7,000,000, as described above.

Moreover, the molecular weight distribution (Mw/Mn) of the (A) component is 1.4 to 3.0, preferably 1.4 to 2.8, more preferably 1.4 to 2.6, as described above.

Furthermore, in the present embodiment, the unreacted (a1) component contained in the powdery paper-strengthening agent is 1,000 ppm or less as described above.

As described above, according to the present embodiment, a powdery paper-strengthening agent having a high molecular weight and a controlled molecular weight distribution and exhibiting excellent paper-strengthening effect can be obtained.

### <Paper-Strengthening Agent Solution>

The paper-strengthening agent solution according to one embodiment of the present invention comprises the above-described powdery paper-strengthening agent and water.

A method of preparing the paper-strengthening agent solution is not particularly limited. By way of an example, the method of preparing the paper-strengthening agent solution may be a method of adding water to a powdery paper-strengthening agent in a batch for mixing them, or a method of dividing water and adding them to a powdery paper-strengthening agent for mixing them. A mixing means is not particularly limited. By way of an example, the mixing means is by way of a stirrer or the like. Moreover, at the time of mixing, heating may be performed. A heating temperature is usually about 5 to 40° C., preferably about 10 to 30° C.

A solid content concentration of the paper-strengthening agent solution is not particularly limited. By way of an example, the solid content concentration is 0.01 to 2% by mass. Moreover, a viscosity (25° C.) of the paper-strengthening agent solution (an aqueous solution having a concentration of 1% by mass) is about 1 to 100 mPa·s. Besides, the viscosity can be measured with a Brook Field viscometer (B-type viscometer).

Various additives may be compounded in the paper-strengthening agent solution, if necessary. The additives are acids, alkalis, anti-foaming agents, preservatives, chelating agents such as citric acid, water-soluble aluminum compounds, Glauber's salts, urea, polysaccharides, or the like.

As described above, the paper-strengthening agent solution of the present embodiment comprises the above-described powdery paper-strengthening agent. Therefore, the paper-strengthening agent solution exhibits excellent paper-strengthening effect.

### <Paper>

The paper according to one embodiment of the present invention can be obtained by using the above-described paper-strengthening agent solution. The paper of the present embodiment has a good formation and excellent specific burst strength and specific compressive strength by using the above-described paper-strengthening agent solution. A method of producing the paper of the present embodiment is not particularly limited. By way of an example, the method of producing the paper comprises including a paper-strengthening agent solution in a raw material pulp slurry, coating it on a surface of a base paper, or the like.

When the paper-strengthening agent solution is included in the raw material pulp slurry, the paper-strengthening agent solution is added to the pulp slurry and then subjected to papermaking. An amount of the paper-strengthening agent solution used (in terms of solid content) is not particularly limited. By way of an example, the amount of the paper-strengthening agent solution used is about 0.01 to 4.0% by mass based on a dry weight of a pulp.

A type of the pulp is not particularly limited. By way of an example, the type of the pulp is of a chemical pulp such as Leaf Bleached Kraft Pulp (LBKP) and Needle Bleached Kraft Pulp (NBKP); a mechanical pulp such as Ground Pulp (GP), Refiner Ground Pulp (RGP), and Thermomechanical Pulp (TMP); a recycled pulp such as a waste corrugated fiberboard, or the like. Besides, when the paper-strengthening agent solution is included in the raw material pulp slurry, fixing agents such as aluminum sulfate; pH adjusters such as sulfuric acid and sodium hydroxide; paper chemicals such as a sizing agent and a wet paper-strengthening agent; loading materials such as talc, clay, kaolin, and calcium carbonate, and the like may be added.

When the paper-strengthening agent solution is coated on the surface of the base paper, it is coated on the surface of the base paper by various known means. A viscosity of a diluted solution of the paper-strengthening agent solution at the time of coating is not particularly limited. By way of an example, the viscosity of the diluted solution is 1 to 40 mPa·s at a temperature of 50° C. A type of the base paper is not particularly limited. By way of an example, uncoated paper made from wood cellulose fibers can be used as the base paper. A coating means is not particularly limited. By way of an example, the coating means is a bar coater, a knife coater, an air knife coater, a calender, a gate roll coater, a blade coater, a two-roll size press, a rod metering, or the like.

A coating amount of the paper-strengthening agent solution (in terms of solid content) is not particularly limited. By way of an example, the coating amount is preferably about 0.001 to 2 g/m², more preferably about 0.005 to 1 g/m².

As described above, the paper of the present embodiment has a good formation and excellent specific burst strength and specific compressive strength by using the paper-strengthening agent solution.

Therefore, the paper of the present embodiment can be used for various products. For example, the paper of the present embodiment can be appropriately used for coated base paper, newspaper, liner, core, a paper tube, printing writing paper, form paper, PPC paper, cup base paper, inkjet paper, heat-sensitive paper, or the like.

One embodiment of the present invention has been described above. The present invention is not particularly limited to the above-described embodiment. Besides, the above-described embodiment mainly describes an invention having the following configurations.

(1) A powdery paper-strengthening agent, comprising a branched (meth)acrylamide-based polymer (A) having a weight-average molecular weight of 1,000,000 to 8,000,000 and a molecular weight distribution of 1.4 to 3.0, wherein the branched (meth)acrylamide-based polymer (A) comprises, as constituent monomers, (meth)acrylamide (a1), a crosslinkable unsaturated monomer (a2), and at least one of a cationic unsaturated monomer (a3) and an anionic unsaturated monomer (a4), and wherein a content of unreacted (a1) component is 1,000 ppm or less.

According to such a configuration, the powdery paper-strengthening agent has a high molecular weight and a controlled molecular weight distribution, and exhibits excellent paper-strengthening effect.

(2) The powdery paper-strengthening agent of (1), wherein a content of the (a1) component is 59.5 to 98 mol % in the constituent monomers, a content of the (a2) component is 0.001 to 1 mol % in the constituent monomers, a content of the (a3) component is 0.5 to 20 mol % in the constituent monomers, and a content of the (a4) component is 0.5 to 20 mol % in the constituent monomers.

According to such a configuration, the powdery paper-strengthening agent is easy to appropriately increase the weight-average molecular weight and to exhibit more excellent paper-strengthening effect.

(3) The powdery paper-strengthening agent of (1) or (2), wherein the (a4) component comprises at least ones of unsaturated sulfonic acids and salts thereof.

According to such a configuration, the powdery paper-strengthening agent increases in weight-average molecular weight to 1,000,000 to 8,000,000, and easily exhibits more excellent paper-strengthening effect.

(4) A method of producing a powdery paper-strengthening agent of any one of (1) to (3), comprising a step (I) of polymerizing a monomer component comprising an (a1) component, an (a2) component, and at least one of an (a3) component and an (a4) component to obtain a branched (meth)acrylamide-based polymer (A) and a step (II) of precipitating the (A) component in an organic solvent (B).

According to such a configuration, the obtained powdery paper-strengthening agent has a high molecular weight and a controlled molecular weight distribution, and exhibits excellent paper-strengthening effect.

(5) The method of (4), wherein the (B) component comprises at least one selected from the group consisting of monoalcohol, acetone, and diethyl ether.

According to such a configuration, in the obtained powdery paper-strengthening agent, a content of a monomer such as an unreacted (a1) component is more easily reduced, and an amount of heat of the powdery paper-strengthening agent at the time of drying can be reduced.

(6) A paper-strengthening agent solution comprising the powdery paper-strengthening agent of any one of (1) to (3) and water.

According to such a configuration, the paper-strengthening agent solution exhibits excellent paper-strengthening effect.

(7) Paper obtained by using the paper-strengthening agent solution of (6).

According to such a configuration, the obtained paper has a good formation and excellent specific burst strength and specific compressive strength by using the paper-strengthening agent solution.

### EXAMPLE

Hereinafter, the present invention will be specifically described with reference to Examples. The present invention is not limited to these Examples. Besides, unless otherwise specified, “part(s)” and “%” in Examples and Comparative examples are based on weight.

The abbreviations of the compounds are shown below.

AM: Acrylamide

MBAA: N,N′-methylenebisacrylamide

TAF: 1,3,5-triacryloylhexahydro-1,3,5-triazine

DMAA: N,N-dimethylacrylamide

DM: N,N-dimethylaminoethyl methacrylate

DML: N,N-dimethylaminoethyl methacrylate benzyl chloride

IA: Itaconic acid

AA: Acrylic acid

SMAS: Sodium methallylsulfonate

APS: Ammonium persulfate

V-50: 2,2′-azobis(2-amidinopropane) dihydrochloride

### (Weight-Average Molecular Weight and Molecular Weight Distribution of (A) Component)

The weight-average molecular weight and the molecular weight distribution were measured by gel permeation chromatography (GPC) method under the following measurement conditions.

GPC body: Manufactured by Tosoh Corporation

Column: One Guard column PWXL and two GMPWXL manufactured by Tosoh Corporation (temperature at 40° C.)

Eluent: 0.5 mol/L acetate buffer (0.5 mol/L acetic acid (manufactured by Wako Pure Chemical Industries, Ltd.)+0.5 mol/L aqueous solution of sodium acetate (manufactured by Kishida Chemical Co., Ltd.), pH: about 4.2)

Flow rate: 0.8 mL/min

Detector: TDA MODEL 301 manufactured by Viscotech Co. Ltd. (a concentration detector, a 90° light scattering detector, and a viscosity detector (temperature at 40° C.)) RALLS method

Measurement sample: Measurement was performed by diluting the (A) component with a deionized water so that the solid content concentration became 0.5%, then adding a sodium hydroxide aqueous solution until the pH reached 10 to 12, immersing the mixture in a hot water bath at 80° C. or higher for 1 hour, then adjusting the pH to 6 to 8 with sulfuric acid, and diluting the mixture to 0.025% with an eluent.

### (Content of Unreacted (a1) Component in Powdery Paper-Strengthening Agent)

The powdery paper-strengthening agent was diluted with the following eluent so as to have a solid content concentration of 0.2%, and then subjected to HPLC using the eluent to calculate a content of unreacted (a1) component.

### (Measurement Condition)

Column: CAPCELL PAC C18 MG II SS manufactured by Shiseido Company, Limited; 1.5 mm I.D.×250 mm

Eluent: Water/acetonitrile=95/5 solution comprising N/100 sodium dodecyl sulfate (adjusted to pH 2.3 with phosphoric acid)

Detector: NANOSPACE SI-2 UV-VIS detector 3002 manufactured by Shiseido Company, Limited

Detection wavelength: 205 nm

### Example 1

581.3 parts of ion-exchanged water were put into a reactor equipped with a stirrer, a thermometer, a reflux cooling tube, a nitrogen gas introduction tube, and two dropping funnels, removed of oxygen in a reaction system through nitrogen gas, and then heated to 90° C. In one of the dropping funnels, 628.17 parts of 50% aqueous solution of AM, 0.0758 parts of MBAA, 1.46 parts of DMAA, 23.18 parts of DM (11.56 parts of 62.5% sulfuric acid for DM neutralization; 100% neutralization of DM), 46.47 parts of 60% aqueous solution of DML, 12.79 parts of IA, 8.86 parts of 80% aqueous solution of AA, 6.218 parts of SMAS, and 404.07 parts of ion-exchanged water were charged, and the pH was adjusted to 3 with 62.5% sulfuric acid. Moreover, 0.6 part of APS and 180 parts of ion-exchanged water were charged in the other dropping funnel. Next, monomer and catalyst were added dropwise into the system with both dropping funnels over about 3 hours. After completion of the dropping, 0.4 parts of APS and 10 parts of ion-exchanged water were put into the system and kept warm for 1 hour, and ion-exchanged water was charged into the system so as to have a solid content concentration of 20.0% to obtain an aqueous solution of an (A-1) component.

Next, 100 parts of the obtained aqueous solution of the (A-1) component were added dropwise into 1,500 parts of methanol, and then the mixture was filtered through a wire mesh (100 mesh, SUS304) to obtain a precipitate. The mixture was dried in a circulation dryer at a temperature of 105° C. for 3 hours and then pulverized in a ball mill for 2 minutes to obtain a powdery paper-strengthening agent. Table 1 shows a weight-average molecular weight, a molecular weight distribution, and a content of unreacted (a1) component (the same shall apply hereinafter).

### Examples 2 to 17, Comparative Examples 1 to 3

Powdery paper-strengthening agents were obtained in the similar manner as in Example 1 except that they were changed in composition to that shown in Table 1.

### Example 18

A powdery paper-strengthening agent was obtained in the similar manner as in Example 1 except that acetone was used instead of methanol for the precipitation.

### Comparative Example 4

A powdery paper-strengthening agent was obtained in the similar manner as in Example 1 except that the precipitate was dried in a circulation dryer at a temperature of 105° C. for 20 hours and then pulverized.

### Comparative Example 5

In a reactor similar with that in Example 1, 628.17 parts of 50% aqueous solution of AM, 0.0758 parts of MBAA, 1.46 parts of DMAA, 23.18 parts of DM (11.56 parts of 62.5% sulfuric acid for DM neutralization; 100% neutralization of DM), 46.47 parts of 60% aqueous solution of DML, 12.79 parts of IA, 8.86 parts of 80% aqueous solution of AA, 6.218 parts of SMAS, 1.0 part of APS, and 1,165.37 parts of ion-exchanged water were charged, the pH was adjusted to 3 with 62.5% sulfuric acid, and the whole mixture was stirred to prepare a uniform mixed solution. A container made of parchment paper was placed on a silicone rubber heater (manufactured by ThreeHigh Co., Ltd.), the silicone rubber heater was heated, the container temperature was adjusted to 105° C., and then the mixed solution was poured therein. The mixed solution was polymerized until water was volatilized, and pulverized to obtain a powdery paper-strengthening agent.

### Comparative Example 6

In a reactor similar with that in Example 1, 628.17 parts of 50% aqueous solution of AM, 0.0758 parts of MBAA, 1.46 parts of DMAA, 23.18 parts of DM (11.56 parts of 62.5% sulfuric acid for DM neutralization; 100% neutralization of DM), 46.47 parts of 60% aqueous solution of DML, 12.79 parts of IA, 8.86 parts of 80% aqueous solution of AA, 6.218 parts of SMAS, 1.0 part of APS, and 1,165.37 parts of ion-exchanged water were charged, and the pH was adjusted to 3 with 62.5% sulfuric acid. After sufficiently subjecting an inside of a flask to nitrogen purge, the temperature of the mixed solution was adjusted to 35° C., 3.5 g of 10 wt % V-50 aqueous solution was charged therein as a photopolymerization initiator, and the whole mixture was stirred to make it uniform. The mixed solution was applied on a polyethylene film having a thickness of 0.07 mm so that the thickness became 10 mm or less, irradiated with a high-pressure mercury lamp (400 W, wavelength: 365 nm, light intensity: 20 mW/cm²) to initiate polymerization, and irradiated for 2 hours while allowing nitrogen to flow. After completion of the polymerization, a water-containing gel-like polymer was obtained. The obtained water-containing gel-like polymer was taken out from the container, shredded, dried in a circulation dryer at 105° C. for 20 hours, and then pulverized to obtain a powdery paper-strengthening agent.

TABLE 1

| | Monomer composition (mol %) | | | | | | | | | | | |
|---|---|---|---|---|---|---|---|---|---|---|---|---|
| | (a1) | (a2) | | | | (a3) | | | (a4) | | | |
| | AM | MBAA | TAF | DMAA | Total | DM | DML | Total | IA | AA | SMAS | Total |
| Example 1 | 89.89 | 0.01 | — | 0.3 | 0.31 | 3 | 2 | 5 | 2 | 2 | 0.8 | 4.8 |
| Example 2 | 90.39 | 0.01 | — | 0.3 | 0.31 | 3 | 2 | 5 | 2 | 2 | 0.3 | 4.3 |
| Example 3 | 89.69 | 0.01 | — | 0.3 | 0.31 | 3 | 2 | 5 | 2 | 2 | 1 | 5 |
| Example 4 | 88.485 | 0.015 | — | 0.5 | 0.515 | 3 | 3 | 6 | 3 | 2 | — | 5 |
| Example 5 | 89.4 | — | — | 0.8 | 0.8 | 3 | 2 | 5 | 2 | 2 | 0.8 | 4.8 |
| Example 6 | 90.18 | 0.02 | — | — | 0.02 | 3 | 2 | 5 | 2 | 2 | 0.8 | 4.8 |
| Example 7 | 90.185 | — | 0.015 | — | 0.015 | 3 | 2 | 5 | 2 | 2 | 0.8 | 4.8 |
| Example 8 | 89.89 | — | 1 | 0.3 | 0.31 | 3 | 2 | 5 | 2 | 2 | 0.8 | 4.8 |
| Example 9 | 90.18 | — | — | 0.02 | 0.02 | 3 | 2 | 5 | 2 | 2 | 0.8 | 4.8 |
| Example 10 | 90.89 | 0.01 | — | 0.3 | 0.31 | 3 | 2 | 5 | 3 | — | 0.8 | 3.8 |
| Example 11 | 89.89 | 0.01 | — | 0.3 | 0.31 | 3 | 2 | 5 | — | 4 | 0.8 | 4.8 |
| Example 12 | 83.796 | 0.004 | — | 0.3 | 0.304 | 15 | — | 15 | 0.4 | — | 0.5 | 0.9 |
| Example 13 | 97.99 | 0.01 | — | 0.4 | 0.41 | 0.6 | — | 0.6 | 0.4 | — | 0.6 | 1 |
| Example 14 | 69.096 | 0.004 | — | 0.4 | 0.404 | 15 | — | 15 | — | 15 | 0.5 | 15.5 |
| Example 15 | 83.19 | 0.01 | — | 0.4 | 0.41 | 0.6 | — | 0.6 | — | 15 | 0.8 | 15.8 |
| Example 16 | 84.496 | 0.004 | — | 0.5 | 0.504 | 15 | — | 15 | — | — | — | — |
| Example 17 | 95.496 | 0.004 | — | 0.5 | 0.504 | — | — | — | 4 | — | — | 4 |
| Example 18 | 89.89 | 0.01 | — | 0.3 | 0.31 | 3 | 2 | 5 | 2 | 2 | 0.8 | 4.8 |
| Comparative example 1 | 89.5 | — | — | — | — | 3 | 2 | 5 | 2 | 2 | 1.5 | 5.5 |
| Comparative example 2 | 90.939 | 0.001 | — | 0.01 | 0.011 | 3 | 2 | 5 | 2 | 2 | 0.05 | 4.05 |
| Comparative example 3 | 88.99 | 0.01 | — | 0.5 | 0.51 | 3 | 2 | 5 | 2 | 2 | 1.5 | 5.5 |
| Comparative example 4 | 89.89 | 0.01 | — | 0.3 | 0.31 | 3 | 2 | 5 | 2 | 2 | 0.8 | 4.8 |
| Comparative example 5 | 89.89 | 0.1 | — | 0.3 | 0.31 | 3 | 2 | 5 | 2 | 2 | 0.8 | 4.8 |
| Comparative example 6 | 89.89 | 0.1 | — | 0.3 | 0.31 | 3 | 2 | 5 | 2 | 2 | 0.8 | 4.8 |

| | | Physical property | | |
|---|---|---|---|---|
| | | Weight-average | Molecular weight | |
| | | molecular weight | distribution | Unreacted (a1) |
| | Producing method | (unit: 10K) | (Mw/Mn) | component (ppm) |
| Example 1 | Aqueous solution | 520 | 1.9 | 200 |
| | polymerization → Methanol | | | |
| | precipitation | | | |
| Example 2 | Aqueous solution | 120 | 1.5 | 160 |
| | polymerization → Methanol | | | |
| | precipitation | | | |
| Example 3 | Aqueous solution | 740 | 2.3 | 100 |
| | polymerization → Methanol | | | |
| | precipitation | | | |
| Example 4 | Aqueous solution | 250 | 2.6 | ND |
| | polymerization → Methanol | | | |
| | precipitation | | | |
| Example 5 | Aqueous solution | 350 | 2.9 | 240 |
| | polymerization → Methanol | | | |
| | precipitation | | | |
| Example 6 | Aqueous solution | 280 | 2.8 | 600 |
| | polymerization → Methanol | | | |
| | precipitation | | | |
| Example 7 | Aqueous solution | 270 | 2.9 | 600 |
| | polymerization → Methanol | | | |
| | precipitation | | | |
| Example 8 | Aqueous solution | 540 | 2 | 250 |
| | polymerization → Methanol | | | |
| | precipitation | | | |
| Example 9 | Aqueous solution | 250 | 2.4 | 100 |
| | polymerization → Methanol | | | |
| | precipitation | | | |
| Example 10 | Aqueous solution | 470 | 1.9 | 160 |
| | polymerization → Methanol | | | |
| | precipitation | | | |
| Example 11 | Aqueous solution | 520 | 2 | 200 |
| | polymerization → Methanol | | | |
| | precipitation | | | |
| Example 12 | Aqueous solution | 380 | 2.2 | 140 |
| | polymerization → Methanol | | | |
| | precipitation | | | |
| Example 13 | Aqueous solution | 510 | 2.3 | 100 |
| | polymerization → Methanol | | | |
| | precipitation | | | |
| Example 14 | Aqueous solution | 295 | 2.2 | 40 |
| | polymerization → Methanol | | | |
| | precipitation | | | |
| Example 15 | Aqueous solution | 410 | 2 | ND |
| | polymerization → Methanol | | | |
| | precipitation | | | |
| Example 16 | Aqueous solution | 350 | 2.9 | 200 |
| | polymerization → Methanol | | | |
| | precipitation | | | |
| Example 17 | Aqueous solution | 350 | 2.9 | 200 |
| | polymerization → Methanol | | | |
| | precipitation | | | |
| Example 18 | Aqueous solution | 500 | 1.9 | 160 |
| | polymerization → Acetone | | | |
| | precipitation | | | |
| Comparative | Aqueous solution | 50 | 2.4 | 160 |
| example 1 | polymerization → Methanol | | | |
| | precipitation | | | |
| Comparative | Aqueous solution | 80 | 2.4 | 100 |
| example 2 | polymerization → Methanol | | | |
| | precipitation | | | |
| Comparative | Aqueous solution | 950 | 3.3 | 200 |
| example 3 | polymerization → Methanol | | | |
| | precipitation | | | |
| Comparative | Aqueous solution | 500 | 3.3 | 400 |
| example 4 | polymerization → Heating | | | |
| | (100° C.) | | | |
| Comparative | Boiling | 200 | 4.2 | 1200 |
| example 5 | polymerization method | | | |
| Comparative | Ultraviolet | 100 | 3.6 | 2300 |
| example 6 | polymerization method | | | |

### (Preparation of Paper-Strengthening Agent Solution)

An ion-exchanged water was added to the powdery paper-strengthening agent of each Example and Comparative example so that the solid content concentration became 1.0% to prepare a paper-strengthening agent solution.

### (Evaluation on Papermaking)

### Evaluation Examples 1 to 18, Comparative Evaluation Examples 1 to 6

A waste corrugated fiberboard was beaten with a Niagara beater, and 1.5% of aluminum sulfate was added to a pulp adjusted to have 380 mL of Canadian Standard Freeness (C.S.F), and 5% of a sodium hydroxide aqueous solution was added to adjust the pH to 6.7. Next, the above-described paper-strengthening agent solution was added at 1% to the pulp in terms of solid content, and the mixture was stirred, and then subjected to papermaking so as to have a basis weight of 180 g/m² with a TAPPI sheet machine and subjected to press dehydration at 5 kg/cm² for 2 minutes. Then, it was dried in a rotary dryer at 105° C. for 3 minutes and controlled in humidity for 24 hours under a condition of a temperature at 23° C. and a humidity of 50% to obtain paper.

### (Formation (Coefficient Variation of Formation))

A value obtained by taking a passing light (brightness) from the paper obtained above into a commercially available measuring instrument (Trade name “Personal image processing system Hyper-700”, manufactured by OBS) and statistically analyzing the brightness distribution was used as a coefficient variation of formation. The results show that the smaller the coefficient variation of formation is, the better the formation is. The results are shown in Table 2 (the same shall apply hereinafter).

### (Specific Burst Strength)

Using the paper obtained above, a specific burst strength (kPa·m²/g) was measured according to JIS P 8131.

### (Specific Compressive Strength)

Using the paper obtained above, a specific compressive strength (N·m²/g) was measured according to JIS P 8126.

TABLE 2

| | | | Specific burst | |
|---|---|---|---|---|
| | Powdered paper | Coefficient variation | strength | Specific compressive |
| | strengthening agent | of formation (%) | (kPa · m²/g) | strength (N · m²/g) |
| Evaluation example | Example 1 | 93.5 | 3.76 | 218 |
| 1 | | | | |
| Evaluation example | Example 2 | 23.4 | 3.68 | 210 |
| 2 | | | | |
| Evaluation example | Example 3 | 23.6 | 3.79 | 220 |
| 3 | | | | |
| Evaluation example | Example 4 | 23.8 | 3.72 | 210 |
| 4 | | | | |
| Evaluation example | Example 5 | 23.6 | 3.68 | 211 |
| 5 | | | | |
| Evaluation example | Example 6 | 23.6 | 3.68 | 211 |
| 6 | | | | |
| Evaluation example | Example 7 | 23.6 | 3.68 | 210 |
| 7 | | | | |
| Evaluation example | Example 8 | 23.6 | 3.76 | 217 |
| 8 | | | | |
| Evaluation example | Example 9 | 23.5 | 3.71 | 213 |
| 9 | | | | |
| Evaluation example | Example 10 | 23.4 | 3.75 | 217 |
| 10 | | | | |
| Evaluation example | Example 11 | 23.4 | 3.76 | 218 |
| 11 | | | | |
| Evaluation example | Example 12 | 23.8 | 3.72 | 216 |
| 12 | | | | |
| Evaluation example | Example 13 | 23.8 | 3.74 | 218 |
| 13 | | | | |
| Eva5luation example | Example 14 | 24.0 | 3.72 | 213 |
| 14 | | | | |
| Eva7luation example | Example 15 | 23.8 | 3.74 | 214 |
| 15 | | | | |
| Evaluation example | Example 16 | 23.7 | 3.68 | 210 |
| 16 | | | | |
| Evaluation example | Example 17 | 23.6 | 3.68 | 211 |
| 17 | | | | |
| Evaluation example | Example 18 | 23.6 | 3.75 | 217 |
| 18 | | | | |
| Comparative | Comparative example | 23.1 | 3.52 | 208 |
| evaluation example | 1 | | | |
| 1 | | | | |
| Comparative | Comparative example | 23.2 | 3.55 | 206 |
| evaluation example | 2 | | | |
| 2 | | | | |
| Comparative | Comparative example | 27.0 | 3.55 | 209 |
| evaluation example | 3 | | | |
| 3 | | | | |
| Comparative | Comparative example | 26.9 | 3.59 | 209' |
| evaluation example | 4 | | | |
| 4 | | | | |
| Comparative | Comparative example | 26.8 | 3.59 | 209 |
| evaluation example | 5 | | | |
| 5 | | | | |
| Comparative | Comparative example | 94.9 | 3.50 | 207 |
| evaluation example | 6 | | | |
| 6 | | | | |

1: A powdery paper-strengthening agent, comprises a branched (meth)acrylamide-based polymer (A) having a weight-average molecular weight of 1,000,000 to 8,000,000 and a molecular weight distribution of 1.4 to 3.0,
wherein the branched (meth)acrylamide-based polymer (A) comprises as constituent monomers,
a (meta)acrylamide (a1),
a crosslinkable unsaturated monomer (a2), and
at least one of a cationic unsaturated monomer (a3) and an anionic unsaturated monomer (a4), and
wherein a content of unreacted (a1) component is 1,000 ppm or less.

2: The powdery paper-strengthening agent of claim 1, wherein a content of the (a1) component is 59.5 to 98 mol % in the constituent monomers,
wherein a content of the (a2) component is 0.001 to 1 mol % in the constituent monomers,
wherein a content of the (a3) component is 0.5 to 20 mol % in the constituent monomers, and
wherein a content of the (a4) component is 0.5 to 20 mol % in the constituent monomers.

3: The powdery paper-strengthening agent of claim 1, wherein the (a4) component comprises at least ones of unsaturated sulfonic acids and salts thereof.

4: A method of producing a powdery paper-strengthening agent of claim 1, the method comprising
a step (I) of polymerizing a monomer component comprising an (a1) component, an (a2) component, and at least one of an (a3) component and an (a4) component to obtain a branched (meth)acrylamide-based polymer (A), and
a step (II) of precipitating the (A) component with an organic solvent (B).

5: The method of claim 4, wherein the (B) component comprises at least one selected from the group consisting of monoalcohol, acetone, and diethyl ether.

6: A paper-strengthening agent solution comprising a powdery paper-strengthening agent of claim 1 and water.

7: Paper obtained by using a paper-strengthening agent solution of claim 6.
